(19) United States
(12) Patent Application Publication
(10) Pub. No.: US 2003/0147104 A1
(43) Pub. Date: Aug. 7, 2003

(54) Platform scanner

(76) Inventors: Kun-Ming Tseng, Hsinchu City (TW); Jiumder Dai, Tainan City (TW)

Correspondence Address: SUPREME PATENT SERVICES, POST OFFICE BOX 2339, SARATOGA, CA, 95070, US

(21) Appl. No.: 10/072,709

(22) Filed: Feb. 5, 2002

(51) Int. Cl. H04N 1/04

(52) U.S. Cl. 358/474

(57) ABSTRACT

A platform scanner is proposed to serve for a learning aid tool for kids of school age to learn words or painting. The platform scanner comprises a housing and a scanning carrier, in which an opaque handwriting board is disposed on an outside portion of the housing, and the scanning carrier is located on the handwriting board. Moreover, a transmission shaft is arranged in a direction parallel with the handwriting board, and one end of the scanning carrier is mounted on the transmission shaft so that the scanning carrier can be horizontally moved along the transmission shaft for scanning and reading data on the handwriting board.

### FIELD OF THE INVENTION

This invention relates to a platform scanner, particularly to a learning aid tool of image input device for kids to learn words or painting before school age.

### BACKGROUND OF THE INVENTION

The scanner, which is already a matured product in the computer peripherals, is designed usually for professional people to scan and input images to a computer for storage or further processing.

As shown in FIG. 1, a generic platform scanner 10 has a scanning carrier 11, which is disposed in the housing 20 of the scanner, for scanning and reading image data. The housing 20 is generally composed of a top and a bottom housing body 21, 22, in which a glass plate 12 for holding documents is provided to the top housing body 21, namely, a transparent glass plate 12 is mounted above the scanning carrier 11 to hold a document 13. Before scanning, the document 13 is firstly placed on the glass plate 12, then a document lid 14 is covered and the scanning carrier 11 is started and moved horizontally to scan and read the paper.

FIG. 2 shows a CIS (Contact image sensor) platform scanner. In this figure, a CIS module 15 disposed in the scanning carrier 11 comprises a light source 16, a lens 17, and a circuit board 18. The circuit board 18 further contains a photo-sensor 19, which is supposed to receive the image data reflected after travelling a trip (A) and penetrated through the lens 17. The signals of the image data of the document 13 sensed by the CIS module 15 are then inputted to a computer after conversion and processing.

Let's return to FIG. 1 again. The scanning carrier 11 is driven by a transmission mechanism having a motor to move horizontally for scanning and reading a whole page image data of the document 13. The existing platform scanner, however, is not as acceptable as a toy to the kids before school age. Therefore, the whiteboard (handwriting board) or the like has been proposed for the sake of learning aids, which is imperfect as the learnt words or data cannot be stored and recalled for next-time reference or revision.

### SUMMARY OF THE INVENTION

The primary object of this invention is to provide a platform scanner for image input, which is a learning aid tool as acceptable as a toy to kids before school age.

Another object of this invention is to provide a platform scanner for image input, in which a scanning carrier is disposed at an outside portion of the scanner's housing, therefore it can be moved manipulatively for scanning and reading the data on a handwriting board.

In order to realize above said object, the platform scanner of this invention comprises a scanning carrier and an opaque handwriting board, in which the handwriting board is disposed on the top end of the housing, and the scanning carrier on the handwriting board; and one end of the scanning carrier is mounted on the transmission shaft such that the scanning carrier could be moved horizontally along the longitudinal direction of the transmission shaft for scanning and reading the data on the handwriting board for input of the same in a computer. A simple operation like this would scarcely lead to any wrong even to kids of school age.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a schematic view showing a conventional platform scanner;

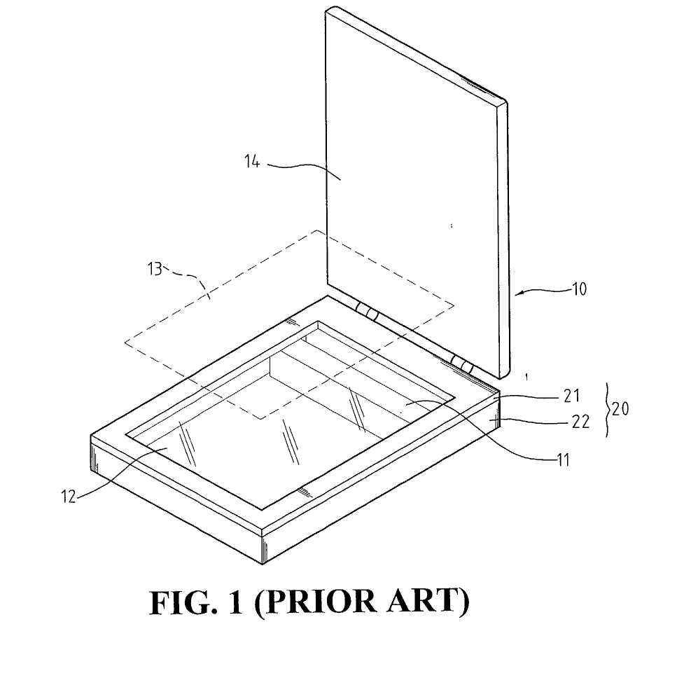

FIG. 2 is a schematic view showing the scanning and reading state of a CIS module;

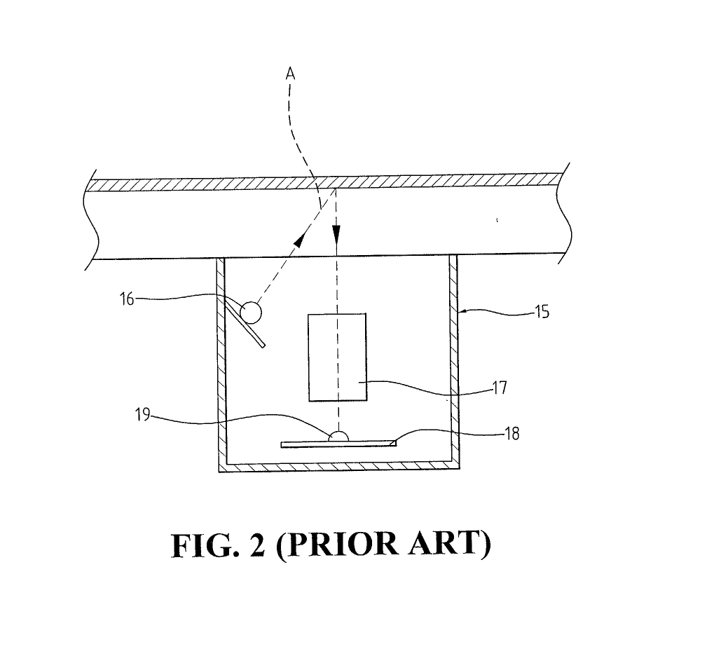

FIG. 3 is a schematic view of a platform scanner of this invention; and

FIG. 4 is a cutaway sectional view of the platform scanner of this invention.

### DETAILED DESCRIPTION OF THE INVENTION

The basic operating principle of a platform scanner of this invention is about the same with a conventional CIS (Contact image sensor) platform scanner, in which a scanning carrier scans and reads the image data, which is then converted and processed and inputted to a computer for storage or further use.

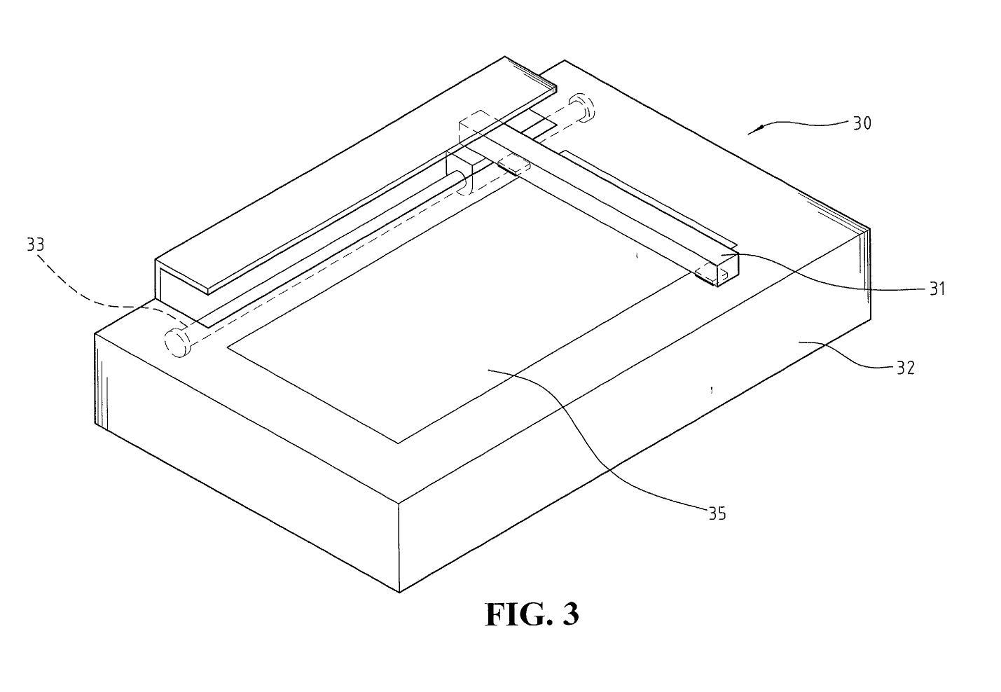

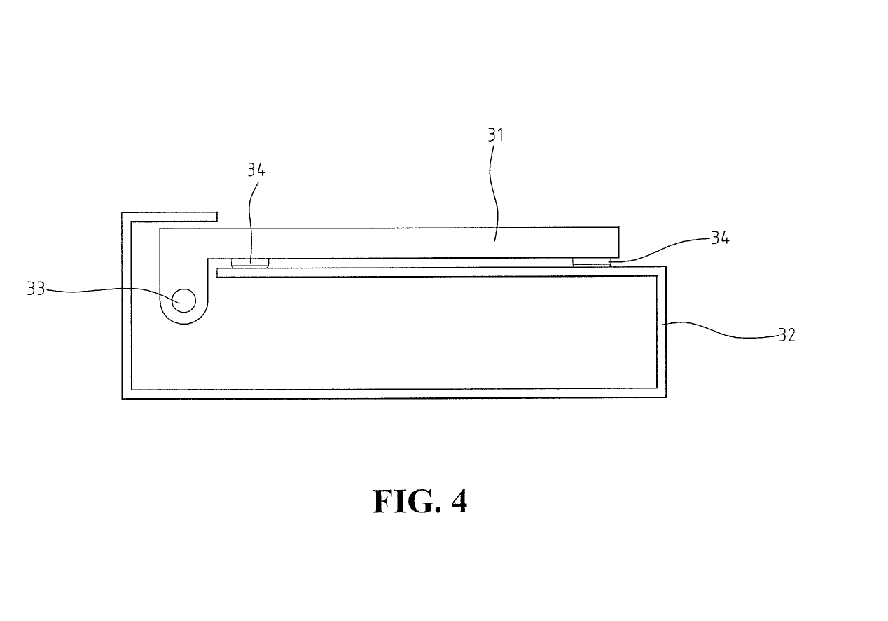

In FIGS. 3 and 4, a scanner 30 of this invention has a scanning carrier 31 disposed at an outside portion of the housing 32 of the scanner. As a particularity of this invention, an opaque handwriting board 35 is located externally on the housing 32 and the scanning carrier 31 resided on the handwriting board 35 is moved horizontally and stably for scanning and reading image data thereof. A transmission shaft 33 is arranged on the scanner 30 in a direction parallel with the handwriting board 35, and one end of the scanning carrier 31 is mounted on the transmission shaft 33 such that the scanning carrier 31 can scan and read the horizontal movement of the transmission shaft 33.

Regarding to maintenance and control of the field depth between the handwriting board 35 and a CIS module (not shown) of the scanning carrier 31, a sliding piece 34 is padded on the housing 32 and under two ends of the scanning carrier 31 respectively, such that the CIS module would closely cling to the target (the handwriting board 35) by taking advantage of the gravity of the scanning carrier 31 while the sliding pieces 34 under the scanning carrier 31 are responsible to maintain and control the field depth between the CIS module and the target in order to keep scanning quality. Besides, the sliding pieces 34 might be substituted by roller wheels for improving smoothness of horizontal movement of the scanning carrier 31.

Another particularity of this invention is that the scanning carrier 31 can be manipulatively and horizontally moved in the scanning direction, namely, moved along the longitudinal direction of the transmission shaft 33 for data scanning and reading to thereby waive the known motor power transmission mechanism and reduce components required, and accordingly cost and time for assembling of a scanner.

Kids of school age may write or paint on the handwriting board 35 of the scanner 30 just like what they are used to do to a generic writing practice board, and simply control with hand to move the scanning carrier 31 horizontally for input of the words or paints they have just made to a computer for storage that can be recalled next time for review or revision.

In a preferred embodiment of this invention, the handwriting board 35 could be a whiteboard, and the transmission shaft 33 is mounted in the housing 32.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A platform scanner, comprising:
a housing, and
a scanning carrier having an inside CIS (Contact image sensor) module, in which an opaque handwriting board is disposed at an outside portion of the housing, and the scanning carrier is located on the handwriting board; in which a sliding piece is padded under two sides at the bottom end of the scanning carrier respectively for maintenance and control of the filed depth between the scanning carrier and the handwriting board; a transmission shaft is arranged on the scanner in a direction parallel with the handwriting board; and one end of the scanning carrier is mounted on the transmission shaft to facilitate horizontal movement of the scanning carrier along longitudinal direction of the transmission shaft for scanning and reading data on the handwriting board.

2. The platform scanner according to claim 1, in which the scanning carrier movement is controlled manipulatively to move in a scanning direction for scanning and reading data.

3. The platform scanner according to claim 2, in which the handwriting board is a whiteboard.

4. The platform scanner according to claim 2, in which the transmission shaft is disposed in the housing.

5. The platform scanner according to claim 1, in which the sliding piece is a roller wheel.
